(19) United States
(12) Patent Application Publication
(10) Pub. No.: US 2012/0195265 A1
(43) Pub. Date: Aug. 2, 2012

(54) ACK/NACK FEEDBACK METHOD AND COMMUNICATION APPARATUS USING SAME

(75) Inventors: Kyung Ho Kim, San Jose, CA (US); Ki Bum Kwon, Ansan-si (KR)

(73) Assignee: PANTECH CO., LTD., Seoul (KR)

(21) Appl. No.: 13/500,610

(22) PCT Filed: Oct. 6, 2010
(86) PCT No.: PCT/KR2010/006834

§ 371 Date: Apr. 5, 2012

(30) Foreign Application Priority Data
Oct. 9, 2009 (KR) 10-2009-0096476

(51) Int. Cl. H04W 28/04

(52) U.S. Cl. 370/328

(57) ABSTRACT

Disclosed is a wireless communication system, and particularly, a technology of feedbacking an ACK/NACK or multiple ACK/NACKs through a single uplink component carrier in response to multi downlink information transmitted through multiple component carriers in a wireless communication system.

### CROSS-REFERENCE RELATED APPLICATIONS

This application is the National Stage Entry of International Application No. PCT/KR2010/006834, filed on Oct. 6, 2010 and claims priority from and the benefit of Korean Patent Application No. 10-2009-0096476, filed on Oct. 9, 2009, which are both hereby incorporated by reference for all purposes as if fully set forth herein.

### BACKGROUND

1. Field

The present invention relates to a wireless communication system, and more particularly to a technology of feedbacking an ACK/NACK or multiple ACK/NACKs through a single uplink component carrier in response to multi downlink information transmitted through multiple component carriers in a wireless communication system.

2. Discussion of the Background

With the development in communication systems, consumers including business companies and individuals are using various wireless terminals.

In current mobile communication systems, such as systems of 3rd Generation Partnership Project (3GPP), Long Term Evolution (LTE), and LTE Advanced (LTE-A), which are high-speed large-capacity communication systems capable of transmitting and receiving various data, such as image and wireless data, beyond the voice-based service, not only is the development of technology capable of transmitting large-capacity data as much as that of a wired communication network required, but also indispensably employed is a proper error diction scheme capable of minimizing the loss of information and enhancing the transmission efficiency of the system, thereby improving the system performance.

Technology, which enables a receiver to transmit an acknowledgement (ACK) signal reporting reception success to a transmitter when the receiver has successfully received data and enables a receiver to transmit a non-acknowledgement (NACK) signal requesting retransmission to a transmitter when the receiver has failed in successfully receiving data, is required. Examples of such technology include Automatic Repeat Request (ARQ) technology and Hybrid Automatic Repeat Request (HARQ) technology. In this technology, it is usually preferred that the ACK/NACK signal transmitted by the data receiver is expressed with a small number of bits.

In general, the downlink refers to communication from a base station to a terminal or User Equipment (UE) and the uplink refers to communication from a UE to a base station. In the downlink, the transmitter may be a base station itself or a part of the base station and the receiver may be a UE itself or a part of the UE.

According to the HARQ scheme, which is a combination of the conventional ARQ scheme and a channel coding scheme of a physical layer, not only a transmitter retransmits reception-failed data as in the conventional ARQ scheme but a receiver also stores the reception-failed data without discarding the reception-failed data. Thereafter, the receiver adds the retransmitted data to the stored data, thereby improving the performance gain.

In the ARQ or HARQ scheme, since a receiver should use additional feedback radio resources for feedbacking an ACK/NACK signal to a transmitter, it is necessary to efficiently use the limited feedback radio resources.

In many current communication systems, such as the LTE communication system of the 3GPP, one-to-one correspondence is not established between a downlink sub-frame and an uplink sub-frame, and the downlink sub-frame has a more asymmetric structure than the uplink sub-frame. Therefore, multiple ACK/NACK (acknowledgement and non-acknowledgement within a HARQ) reports for multiple downlink sub-frames need to be transmitted within a single uplink sub-frame.

As used herein, the sub-frame is a basic unit for data transmission, one sub-frame includes two slots, and downlink or uplink scheduling is performed for each sub-frame. Further, one wireless frame includes ten sub-frames.

The number of ACK/NACKs that can be transmitted through one uplink sub-frame is determined by the degree of asymmetry between the downlink and the uplink and whether a downlink Multiple Input Multiple Output antenna (MIMO) mode is employed.

Bundling and multiplexing have been proposed as schemes capable of combining multiple ACK/NACKs in response to multiple downlink sub-frames into a single ACK/NACK response in order to improve the uplink control channel performance.

The bundling used in the LTE TDD refers to technology of ANDing (performing a logical AND operation) data reporting success or failure in receiving multiple downlink sub-frames to each codeword, thereby generating a single bit. For example, in the case of a system in which one uplink sub-frame is transmitted after transmission of four downlink sub-frames, an ACK/NACK feedback signal is generated by ANDing data reception success-failure bit (0 when failure and 1 when success) of four downlink sub-frames to each codeword. The ACK/NACK feedback bit is 1 only when all the four downlink sub-frames have been successfully received, while the ACK/NACK feedback bit is 0 when any of the four downlink sub-frames has not been successfully received.

Further, when a MIMO antenna is used, since two codewords are used, a total of two bits are used as the ACK/NACK feedback bits. Otherwise, one bit is used for the ACK/NACK feedback signal.

In relation to the transmission control for multiple users of the MIMO, a control station may use code book-based technology in order to secure channel state information availability, wherein the control requires only a quantized channel vector rather than complete channel information. Herein, the code book includes predefined weight vectors, that is, codewords, and the MIMO UE determines a best Channel Quality Indicator (CQI) and selects and uses the most proper codeword from the code book based on the best CQI.

The ACK/NACK feedback signal generated in the way as described above is transmitted to a base station through a Physical Uplink Control Channel (PUCCH) having been allocated for ACK/NACK feedback of a receiving UE in the LTE standard.

Therefore, by using the bundling, it is possible to generate an ACK/NACK feedback signal of 1 bit or 2 bits in response to multiple downlink sub-frames and transmit the generated signal to the base station through a single PUCCH.

Meanwhile, the multiplexing in the LTE TDD employs an AND operation of a success-failure indicating bit between codewords to each downlink sub-frame. Therefore, an ACK/NACK bit is generated for each downlink sub-frame regardless of the number of codewords.

For example, in the case of a system in which one uplink sub-frame is transmitted after transmission of four downlink sub-frames, since one ACK/NACK bit is generated for each downlink sub-frame regardless of use of the MIMO, an ACK/NACK feedback signal having a total of four bits is generated.

The ACK/NACK feedback signals generated in this way are transmitted to a base station by using 1b format of a PUCCH. Since the 1b format of a PUCCH can use only two bits, the 1b format of a PUCCH employs channel selection and QPSK modulation in order to transmit an ACK/NACK feedback signal of four bits corresponding to the number of downlink sub-frames.

That is, by using a table relating to ACK/NACK multiplexing transmission defined in the 3GPP standard, a UE transmits an ACK/NACK feedback signal having a total of four bits in the 1b format of the PUCCH to a base station, and the base station receives the feedback signal, identifies success or failure in receiving each downlink sub-frame, and then performs retransmission, etc.

However, the LTE-Advanced (LTE-A) being in current discussion employs multiple component carriers.

In order to satisfy the performance required by the LTE-A, it is necessary to expand the bandwidth. In order to expand the bandwidth, a unit carrier that an existing LTE release 8 UE can have is defined as an element carrier or component carrier, a maximum bandwidth of which is 20 MHz as defined in the LTE.

In the LTE-A, it is possible to consider a bundle including a maximum of five component carriers, which enables expansion of bandwidth up to a maximum of 100 MHz.

Such bundling of a maximum of five component carriers as described above refers to carrier aggregation, and the frequency band assignable by the component carriers may be either consecutive or inconsecutive.

In the LTE-A as described above, since multiple component carriers are used, only the conventional bundling and multiplexing used in the LTE release 8 as described above cannot generate an ACK/NACK feedback signal for sub-frames of all component carriers in a form that can be transmitted through PUCCH format 1a and PUCCH format 1b. Further, a solution for solving this problem has never been discussed at all in the current standards or even in the currently-discussed standards.

Since the ACK/NACK feedback through PUCCH 1a/1b formats of 3GPP release 8 cannot depend on multiple channels, it cannot achieve efficient multiple ACK/NACK feedbacks. Therefore, it may waste resources or change the uplink single carrier characteristics, thereby causing loss of an important uplink coverage.

### SUMMARY

Accordingly, the present invention has been made to solve the above-mentioned problems occurring in the prior art, and the present invention provides technology for notifying multiple ACK/NACKs through a single uplink carrier in response to multiple downlink carriers or downlink assignments.

Also, the present invention provides technology using joint coding technology combined with partial multiplexing and/or partial bundling and PUCCH 2b format in order to notify multiple ACK/NACKs through a single uplink carrier in response to multiple downlink carriers or downlink assignments.

In order to accomplish this object, there is provided a communication apparatus performing ACK/NACK signal feedback, which transmits an ACK/NACK signal in an uplink in a downlink/uplink asymmetric communication system using at least one component carrier, the communication apparatus including: a reception success-failure determination unit for determining success or failure in receiving a multiple downlink signal through each component carrier; an ACK/NACK signal generation unit for selectively generating an ACK/NACK signal indicating success or failure in receiving a multiple downlink signal of at least one component carrier according to the number of component carriers; and a transmission unit for transmitting the ACK/NACK signal through an uplink channel.

In accordance with another aspect of the present invention, there is provided an ACK/NACK signal feedback method by a communication apparatus, which transmits an ACK/NACK signal in an uplink in a downlink/uplink asymmetric communication system using at least one component carrier, the ACK/NACK signal feedback method including: determining success or failure in receiving a multiple downlink signal through each component carrier; selectively generating an ACK/NACK signal indicating success or failure in receiving a multiple downlink signal of at least one component carrier according to the number of component carriers; and transmitting the ACK/NACK signal through an uplink channel, wherein the ACK/NACK signal selectively includes at least one of an initial ACK/NACK signal, a partially bundled ACK/NACK signal, and a partially multiplexed ACK/NACK signal, based on the number of component carriers.

In accordance with another aspect of the present invention, there is provided an ACK/NACK signal transmission method, in which a communication apparatus transmits a multi-ACK/NACK signal, which is a signal reporting success/failure in receiving multiple downlink component carriers, in an uplink in a downlink/uplink asymmetric communication system using multiple component carriers, wherein the communication apparatus transmits the multi-ACK/NACK signal for the multiple downlink component carriers through a single uplink component carrier.

In accordance with another aspect of the present invention, there is provided a communication apparatus for generating a multi-ACK/NACK signal, which is a signal reporting success/failure in receiving multiple downlink component carriers, in an uplink in a downlink/uplink asymmetric communication system using multiple component carriers, wherein the communication apparatus generates the multi-ACK/NACK signal by using partial multiplexing or partial bundling of ACK/NACK data for each downlink component carrier and PUCCH 2b format, and transmits the generated multi-ACK/NACK signal through a single uplink component carrier.

### BRIEF DESCRIPTION OF THE DRAWINGS

FIG. 1 illustrates a wireless communication system to which embodiments of the present invention are applied.

FIG. 2 is a block diagram of a communication apparatus (UE) according to an embodiment of the present invention.

FIG. 3 illustrates a table showing a scheme of generating an ACK/NACK signal based on the number of component carriers according to an embodiment of the present invention.

FIGS. 4 and 5 illustrate a flowchart of an ACK/NACK feedback method according to an embodiment of the present invention.

FIG. 6 illustrates an embodiment of the present invention, in which an ACK/NACK signal generation unit generates an ACK/NACK signal according to a particular order.

FIGS. 7 and 8 illustrate a process of generating an ACK/NACK signal through partial bundling and partial multiplexing according to an embodiment of the present invention.

### DETAILED DESCRIPTION OF THE ILLUSTRATED EMBODIMENTS

Hereinafter, exemplary embodiments of the present invention will be described with reference to the accompanying drawings. In the following description and drawings, the same reference numerals are used to designate the same or similar components, and so repetition of the description on the same or similar components will be omitted. In the following description, a detailed description of known functions and configurations incorporated herein will be omitted when it may make the subject matter of the present invention rather unclear.

Further, in the following description, elements of the present invention may be named by using terms, such as the first, the second, A, B, (a), and (b). However, such terms are used only to discriminate those elements from other elements and do not limit the essence, sequence, or order of the elements. If it is read that one element is “connected”, “combined”, or “attached” to another element, it should understood that not only may the element be directly connected, combined, or attached to said another element but a third element may also be connected, combined, or attached between the element and said another element.

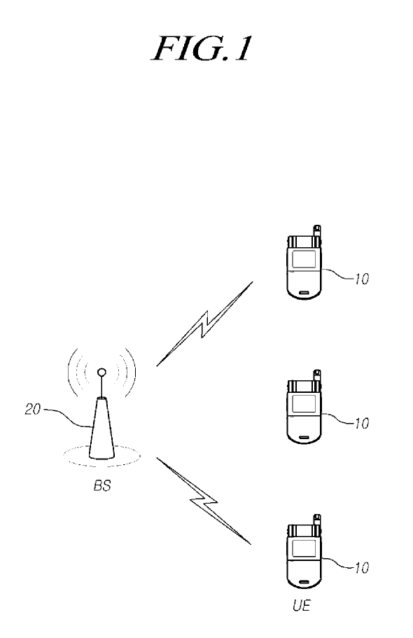

FIG. 1 illustrates a wireless communication system to which embodiments of the present invention are applied.

A wireless communication system is widely arranged in order to provide various communication services, such as services of voice and packet data.

Referring to FIG. 1, the wireless communication system includes a User Equipment (UE) 10 and a Base Station (BS) 20. The UE 10 and the BS 20 use an uplink broadband measurement signal transmission method and a downlink channel estimation method using the same.

In the present specification, the UE 10 should be interpreted to have an inclusive concept referring to a user terminal in a wireless communication, and to include not only a UE in the WCDMA, LTE, and HSPA, but also a Mobile Station (MS), a User Terminal (UT), a Subscriber Station (SS), a wireless device, etc. in the GSM.

The BS 20 or cell generally refers to a fixed station communicating with the UE 10 and may be referred to as another name, such as a Node B, evolved Node B (eNB), a Base Transceiver System (BTS), an access point, and a relay node.

That is, in the present specification, the BS 20 or cell should be interpreted to have an inclusive concept referring to an area covered by a Base Station Controller (BSC) in the CDMA, a Node B of the WCDMA, etc., and to include various coverage areas, such as a mega cell, a macro cell, a micro cell, a pico-cell, a femto cell, and a relay node communication range.

In the present specification, the UE 10 and the BS 20 have inclusive meanings indicating two main transmitting agents used to implement the technology or technical concept described herein and are not limited by the particular terms or words used herein.

There is no limit in the multiple access schemes applied to the wireless communication system. That is, it is possible to apply various multiple access schemes, such as Code Division Multiple Access (CDMA), Time Division Multiple Access (TDMA), Frequency Division Multiple Access (FDMA), Orthogonal Frequency Division Multiple Access (OFDMA), OFDM-FDMA, OFDM-TDMA, and OFDM-CDMA.

For uplink transmission and downlink transmission, it is possible to use either a Time Division Duplex (TDD) scheme using different times for transmission or a Frequency Division Duplex (FDD) scheme using different frequencies for transmission.

The present invention can be applied to resource allocation in the fields of the asynchronous wireless communication, which has evolved up to the LTE and LTE-A through the GSM, WCDMA, and HSPA, and the synchronous wireless communication, which has evolved to the CDMA, CDMA-2000, and UMB. The present invention should not be interpreted to be limited to a particular wireless communication field and should be interpreted to include all technical fields to which the idea of the present invention can be applied.

A wireless communication system to which the present invention is applied can support uplink and/or downlink HARQ and can use a Channel Quality Indicator (CQI) for link adaptation. Further, different multiple access schemes may be employed for the downlink and the uplink. For example, an Orthogonal Frequency Division Multiple Access (OFDMA) scheme may be employed for the downlink, while a Single Carrier-Frequency Division Multiple Access (SC-FDMA) scheme is employed for the uplink.

Radio interface protocols between a UE and a network can be divided into a first layer (L1), a second layer (L2), and a third layer (L3), based on three lower layers of the Open System Interconnection (OSI) model widely known in communication systems. A physical layer belonging to the first layer provides information transfer service using a physical channel.

Meanwhile, in a wireless communication system according to an embodiment of the present invention, one radio frame includes 10 sub-frames, each of which may include two slots. A basic unit for data transmission is the sub-frame, and downlink or uplink scheduling is performed sub-frame by sub-frame. One slot may include multiple OFDM symbols in the time domain and include at least one sub-carrier in the frequency domain. One slot may include six or seven OFDM symbols. However, it goes without saying that the present invention is not limited to this embodiment and can be applied to another type of wireless communication system.

An embodiment of the present invention provides an ACK/NACK signal feedback method, in which a communication apparatus transmits a reception success-failure reporting signal (ACK/NACK signal) in the uplink in an uplink/downlink asymmetric communication system using multiple component carriers. In the method, at least one ACK/NACK signal reporting success or failure in receiving multiple downlink signals of all component carriers is selectively generated based on the number of the component carriers and is then transmitted in the PUCCH format 2b, wherein at least one ACK/NACK signal is selected from an initial ACK/NACK signal, a partially bundled ACK/NACK signal, and a partially multiplexed ACK/NACK signal, based on the number of the component carriers. When the number of the component carriers is two, one of an initial ACK/NACK signal having full bits and a partially bundled ACK/NACK signal is used as the ACK/NACK signal. When the number of the component carriers is three or four, one of a partially bundled ACK/NACK signal and a partially multiplexed ACK/NACK signal is used as the ACK/NACK signal. When the number of the component carriers is five, a partially bundled ACK/NACK signal is used as the ACK/NACK signal.

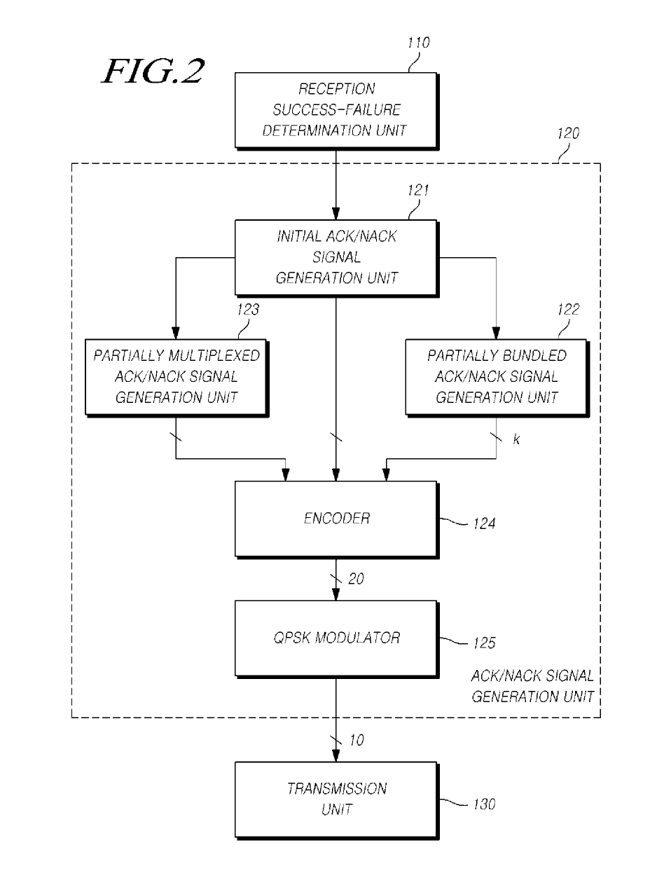

FIG. 2 is a block diagram of a communication apparatus (UE) according to an embodiment of the present invention.

As shown, in order to perform ACK/NACK signal feedback by transmitting a reception success-failure reporting signal (ACK/NACK signal) in a downlink-uplink asymmetric communication system using at least one component carrier, a communication apparatus according to an embodiment of the present invention includes a reception success-failure determination unit 110 for determining success or failure in receiving multiple downlink signals received through each component carrier, an ACK/NACK signal generation unit 120 for selectively generating an ACK/NACK signal indicating success or failure in receiving multiple downlink signals of all component carriers according to the number (CC) of component carriers, and a transmission unit 130 for transmitting an ACK/NACK signal through an uplink channel. Based on the number (CC) of component carriers, the ACK/NACK signal generation unit 120 generates an ACK/NACK signal selectively including at least one of an initial ACK/NACK signal, a partially bundled ACK/NACK signal, and a partially multiplexed ACK/NACK signal.

According to an embodiment of the present invention, it is preferred that an uplink channel used for the ACK/NACK signal feedback employs a PUCCH format 2b. However, the present invention is not limited to the format.

In a wireless communication system according to an embodiment of the present invention, channels used in a physical layer include downlink channels and uplink channels, and the downlink channels or the uplink channels include a Physical Downlink Control Channel (PDCCH) and a Physical Uplink Control Channel (PUCCH), which are physical channels.

In the frequency domain, an uplink sub-frame includes a control region, to which a PUCCH carrying uplink control information is allocated, and a data region, to which a PUSCH carrying user data is allocated, and the PUCCH can support multiple formats.

In other words, sub-frames may have different bits according to the modulation scheme in the transmitted uplink control information. In the current 3GPP or LTE, the format, modulation scheme, and bit number of the PUCCH are defined in TS 36.211 V8.2.0.

PUCCH format 1a and 1b are used in transmitting a Scheduling Request (SR), and PUCCH format 1a/1b is used in transmitting a representative ACK/NACK signal and can transmits information having a total of 1 bit or 2 bits.

Meanwhile, PUCCH format 2 is defined to be used in transmission of the CQI, and PUCCH format 2a/2b is used in transmission of a CQI and representative ACK/NACK signal. The number of bits allowed for each sub-frame is defined as at least 20 bits, and it is preferred that an ACK/NACK signal having bits more than two bits (preferably having 10 bits) generated according to an embodiment of the present invention is fed back through PUCCH format 2b.

For reference, Table 1 below shows PUCCH formats, modulation schemes, and bit numbers, which are supported by the current standards. However, the present invention is not limited to Table 1.

TABLE 1

| PUCCH | Modulation | Number of bits per |
|---|---|---|
| format | scheme | subframe, M_{bit} |
| 1 | N/A | N/A |
| 1a | BPSK | 1 |
| 1b | QPSK | 2 |
| 2 | QPSK | 20 |
| 2a | QPSK + BPSK | 21 |
| 2b | QPSK + QPSK | 22 |

The ACK/NACK signal generation unit 120 includes an initial ACK/NACK signal generation unit 121 for generating an initial ACK/NACK signal, a partially bundled ACK/NACK signal generation unit 122 for generating a partially bundled ACK/NACK signal, a partially multiplexed ACK/NACK signal generation unit 123 for generating a partially multiplexed ACK/NACK signal, an encoder 124 for coding k bits of partially bundled or partially multiplexed data into a predetermined number (N) of bit streams, and a modulator 125 for modulating N bits of coding data into N bit streams.

The initial ACK/NACK signal generation unit 121 generates a reception success signal (ACK signal) reporting success in receiving each multiple downlink sub-frame and codeword, for each component carrier, in the form of bit stream. Therefore, full bit data having a value obtained by multiplying the number (CC) of component carriers by the number of sub-frames of the multiple downlink and the number of codewords (=2) is generated at the initial ACK/NACK signal. For example, when the number of component carriers is three and the number of multiple downlink sub-frames is four, an initial ACK/NACK signal having a total of 24 bits (3×4×2=24) is generated.

The initial ACK/NACK signal generated in this way is either directly input to the encoder 124 or input to the partially bundled ACK/NACK signal generation unit 122 or the partially multiplexed ACK/NACK signal generation unit 123, according to whether the initial ACK/NACK signal has a size that can be accepted by PUCCH format 2b.

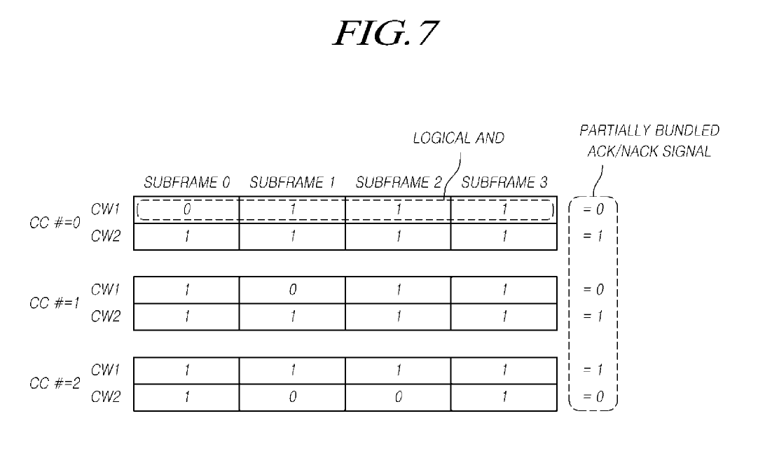

As shown in FIG. 7, the partially bundled ACK/NACK signal generation unit 122 receives the initial ACK/NACK signal and performs a logical AND operation on the ACK/NACK bits of all multiple downlink sub-frames with respect to each codeword (CW1, CW2) within each component carrier, thereby generating a partially bundled ACK/NACK signal including bit streams, the number of which is a twice multiple of the total number of component carriers. For example, when three component carriers (CC #0 to #2) and four downlink sub-frames (sub-frame #0 to #3) are used, a partially bundled ACK/NACK signal having six bits (3×2=6) is generated from the initial ACK/NACK signal of 24 bits.

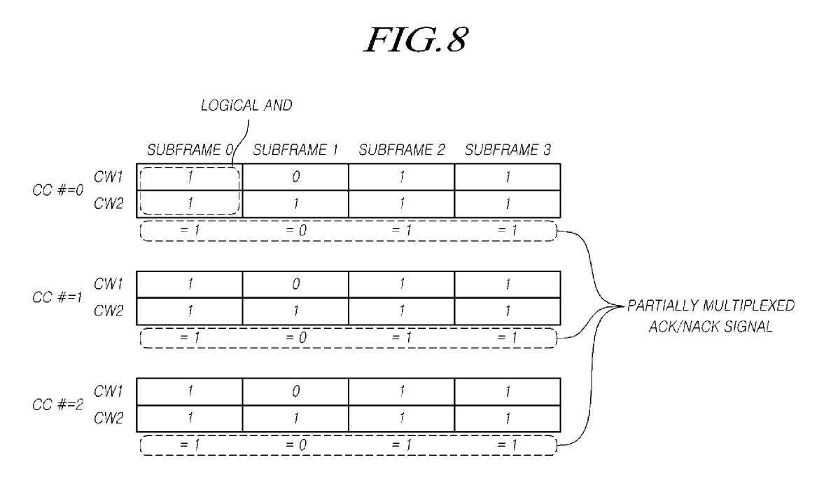

As shown in FIG. 8, the partially multiplexed ACK/NACK signal generation unit 123 receives the initial ACK/NACK signal and performs a logical AND operation on the ACK/NACK bits of all codewords with respect to each multiple downlink sub-frame within each component carrier, thereby generating a partially multiplexed ACK/NACK signal including bit streams, the number of which is equal to the number of multiple downlink sub-frames in each component carrier. For example, when three component carriers (CC #0 to #2) and four downlink sub-frames (sub-frame #0 to #3) are used, a partially multiplexed ACK/NACK signal having twelve bits (3×4=12) is generated from the initial ACK/NACK signal of 24 bits.

Further, the ACK/NACK signal generation unit 120 according to an embodiment of the present invention can generate the ACK/NACK signal in which bit streams of the multiple downlink signal are arranged in a predetermined order based on the component carrier number and the sub-frame number of the multiple downlink signal. That is, at the time of generating the initial ACK/NACK signal, the ACK/NACK signal generation unit 120 may arrange the bit streams in a predetermined order based on the component carrier number and the sub-frame number instead of randomly arranging the bit streams.

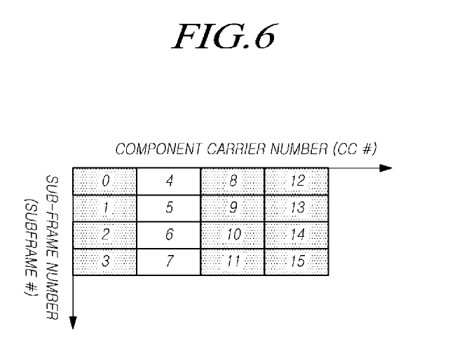

By this arrangement, a transmitter or BS having received the ACK/NACK feedback can identify the turn of a component carrier, the turn of a sub-frame of the component carrier, and the codeword of the sub-frame, reception of which was success or failure, an example of which is described later in more detail with reference to FIG. 6.

The partially bundled ACK/NACK signal and the partially multiplexed ACK/NACK signal generated in this way are input to the encoder 124.

The encoder 124 receives k bits of initial ACK/NACK signal, partially bundled ACK/NACK signal, and partially multiplexed ACK/NACK signal, encodes them, and then outputs a bit stream having a predetermined number (N) of bits. It is preferred that the encoder 124 is a Reed-Muller encoder RM(N,k) wherein N=20. However, the present invention is not limited to the Reed-Muller encoder.

The encoder 124 receives an ACK/NACK signal having a value k that does not exceed N(=20) and encodes the signal into a signal of 20 bits, thereby obtaining a predetermined coding gain. The smaller the value of k, the larger the coding gain.

It is preferred that the modulator 125 is a QPSK modulator, which receives a signal of N bits and outputs a signal of 10 bits through a Quadrature Phase Shift Keying (QPSK) modulator. However, the present invention is not limited to the QPSK modulator.

The ACK/NACK signal generation unit 120 having the construction described above uses one of an initial ACK/NACK signal having full bits and a partially bundled ACK/NACK signal when the number of component carriers is two, uses one of a partially bundled ACK/NACK signal and a partially multiplexed ACK/NACK signal when the number of component carriers is three or four, and uses a partially bundled ACK/NACK signal when the number of component carriers is five.

As used herein, the partial bundling or partial multiplexing are simply referred to as “partial bundling” or “partial multiplexing” in order to discriminate them from the 2-dimensional partial bundling or partial multiplexing considerable in the LTE-A TDD and the conventional bundling and multiplexing techniques used in the LTE TDD.

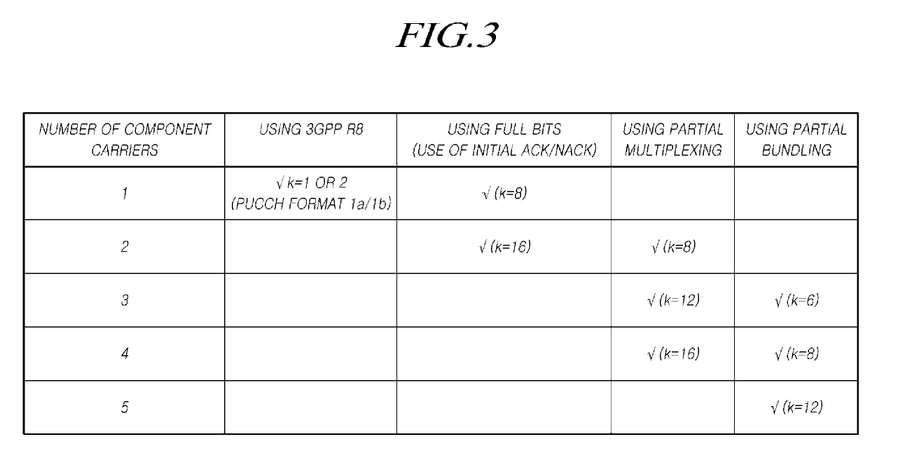

FIG. 3 illustrates a table showing a scheme of generating an ACK/NACK signal based on the number of component carriers according to an embodiment of the present invention.

On an assumption that a total of five downlink component carriers have been allocated to the downlink in an LTE-A of a Frequency Division Duplex (FDD) scheme, the maximum value of an ACK/NACK bit is ten (k=10) and the partial bundling is thus unnecessary. In an RM(N,k) encoding, RM(20, 10) provides a sufficient protection.

However, in a TDD LTE-A system, it is necessary to use the partial multiplexing or partial bundling according to the number of downlink assignments. The partial multiplexing or partial bundling reduces the size of k, that is, compresses the ACK/NACK information bit for all downlink assignments.

As shown in FIG. 3, on an assumption that four sub-frames are the same as those in the case of TDD LTE when only one downlink carrier or only one downlink assignment exists, a maximum of eight ACK/NACK bits should be notified. Then, k=8, and the encoder can provide more strong protection when the encoder generates 20 bits for the modulation. Instead, for the maximum backward compatibility, TDD LTE partial bundling or partial multiplexing is applied.

In the case of two downlink carriers, the total number of ACK/NACK bits is 16. Then, it is possible to use one of three options, which include: 1) a scheme of transmitting entire information (k=16); 2) a scheme of using modified partial multiplexing (k=8); and 3) a scheme of using partial bundling (k=4). If the performance requirement condition is satisfied, the scheme in the case where k=16 should be used for two downlink carriers.

If three downlink carriers or downlink assignments exist, it is possible to apply one of the two schemes, which include: 1) a scheme of using partial multiplexing (k=12); and 2) a scheme of using partial bundling (k=6). If the performance requirement condition is satisfied, the scheme in the case where k=12 should be used for two downlink carriers.

When the number of downlink carriers or downlink assignments is four, one of the two schemes including: 1) a scheme of using partial multiplexing (k=16); and 2) a scheme of using partial bundling (k=8) is applied. If the performance requirement condition is satisfied, it is preferable to use the scheme in the case where k=16 as in the case of two downlink carriers. Otherwise, the scheme in the case where k=8 should be used. Finally, when five downlink carriers or downlink assignments exist, the partial bundling wherein k=10 should be used, since the partial multiplexing wherein k=20 can achieve no coding gain at all when it is used in the PUCCH 2b format.

In brief, according to an embodiment of the present invention, an efficient encoder, such as RM(20,k), is used to encode and compress ACK/NACK information in a TDD LTE-A system. Therefore, the present invention provides an efficient method capable of transferring more information while providing strong and sufficient protection.

An embodiment of the present invention as described above provides a joint encoding scheme for multiple ACK/NACK feedbacks using PUCCH format 2b having a capacity of at least 20 bits used in the 3GPP release 8, which can maintain the single carrier characteristics while enabling multiple ACK/NACK signal transmission even without using multiple resources or multiple channels.

Further, the present invention presents a standard for performing modified partial bundling or partial multiplexing, which is compatible with the 3GPP release 8 and enables compression of ACK/NACK feedbacks for all downlink component carriers requesting ACK/NACK of downlink assignment by using the modified partial bundling or partial multiplexing for a TDD system of the LTE-A.

However, when only one downlink component carrier exists, use of PUCCH format 1a/1b and the joint coding, such as RM(N,k), can provide more strong protection. Further, use of the PUCCH 2b format instead of PUCCH format 1a/1b can support an information bit size up to 20 bits, together with QPSK modulation.

In a TDD LTE-A system, for even an ACK/NACK information size up to a maximum of 40 bits, the partial bundling and partial multiplexing proposed by the present invention can guarantee an encoder output with a size of 20 bits.

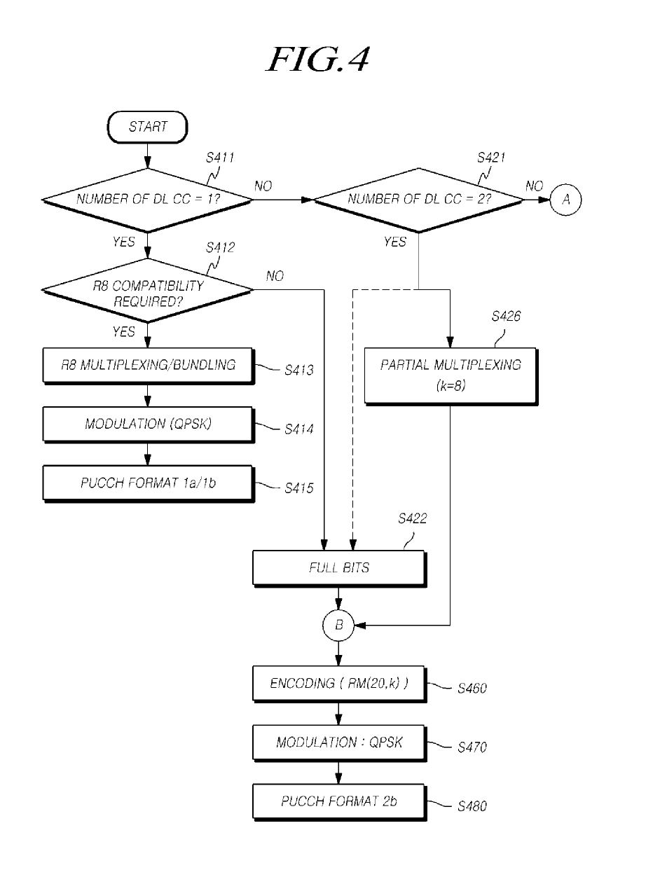

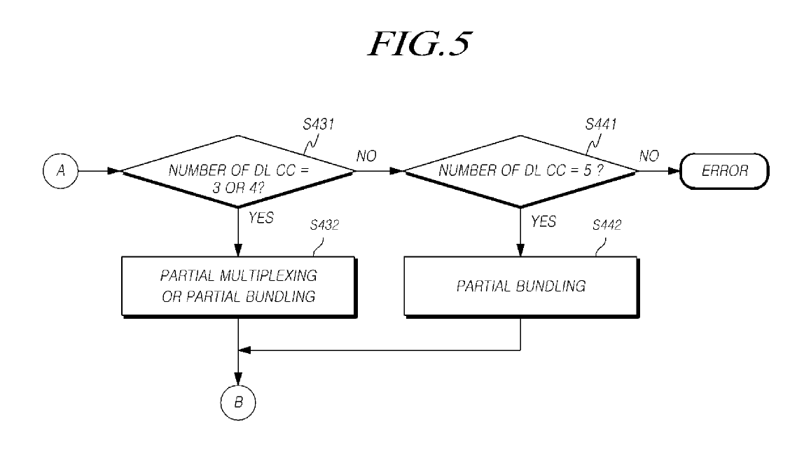

FIGS. 4 and 5 illustrate a flowchart of an ACK/NACK feedback method according to an embodiment of the present invention.

Referring to FIGS. 4 and 5, a communication apparatus according to an embodiment of the present invention determines if the number of component carriers is 1 (step S411). When the number of component carriers is 1, the communication apparatus determines if there is requirement for the compatibility of the conventional LTE release 8 (step S412). When there is requirement for the compatibility of the conventional LTE release 8, the communication apparatus applies the bundling and/or multiplexing in the conventional LTE TDD R8 (step S413), performs modulation (step S414), and then generates and transmits an ACK/NACK feedback signal of 1 bit through PUCCH form a 1a or 1b (step S415).

Meanwhile, when the number of component carriers is not 1 as a result of the determination in step S411, the communication apparatus determines if the number of component carriers is 2 (step S421). When the number of component carriers is 2, the communication apparatus checks the channel condition and selects an initial ACK/NACK full bit signal wherein k=16 when the channel condition is good (step S422). Thereafter, the communication apparatus encodes the signal into a signal of 20 bits by using an MR encoder as described above, etc. (step S460), QPSK-modulates the encoded signal by a modulator, thereby generating a final ACK/NACK feedback signal of 10 bits (step S470), and then transmits the final signal through PUCCH format 2b (step S480).

When the channel condition is not good as a result of the determination of if the channel condition is good, the communication apparatus multiplexes the initial ACK/NACK full bit signal (k=16) to generate a partially multiplexed ACK/NACK signal wherein k=8 (step S426). Then, as in steps S460 to S480, the communication apparatus performs encoding of the signal into a 20 bit signal and QPSK modulation into a 10 bit signal, thereby generating a final 10 bit ACK/NACK feedback signal. Then, the communication apparatus transmits the final signal through PUCCH format 2b.

In the meantime, when the number of component carriers is not 2 as a result of step S421, the communication apparatus determines if the number of component carriers is 3 or 4 (step S431). When the number of component carriers is 3 or 4, the communication apparatus selectively performs partial multiplexing of the initial ACK/NACK full bit signal (k=24 when CC=3 and k=24 when CC=4) to generate a partially multiplexed ACK/NACK signal or partial bundling of the initial ACK/NACK full bit signal (k=6 when CC=3 and k=8 when CC=4) to generate a partially bundled ACK/NACK signal according to the channel condition (step S432).

Thereafter, as in steps S460 to S480, the communication apparatus performs encoding of to the partially bundled ACK/NACK signal or the partially multiplexed ACK/NACK signal into a 20 bit signal and QPSK modulation into a 10 bit signal, thereby generating a final 10 bit ACK/NACK feedback signal. Then, the communication apparatus transmits the final signal through PUCCH format 2b.

In the meantime, when the number (CC) of component carriers is not 3 or 4 as a result of step S431, the communication apparatus determines if the number of component carriers is 5 (step S431). When the number of component carriers is 5, the number of bits of the initial ACK/NACK full bit signal is 40 (k=40), which implies that the partial multiplexing can yield no coding gain at all.

Therefore, when CC is 5, the communication apparatus generates a partially bundled ACK/NACK signal wherein k is 8 (k=8) by performing partial bundling of the initial ACK/NACK full bit signal (k=40) (step S442). Then, as in steps S460 to S480, the communication apparatus performs encoding of the partially bundled ACK/NACK signal into a 20 bit signal and QPSK modulation into a 10 bit signal, thereby generating a final 10 bit ACK/NACK feedback signal. Then, the communication apparatus transmits the final signal through PUCCH format 2b.

FIG. 6 illustrates an embodiment of the present invention, in which an ACK/NACK signal generation unit generates an ACK/NACK signal according to a particular order.

As described above, it is preferred that an ACK/NACK signal generation unit according to an embodiment of the present invention generates ACK/NACK signals in a predetermined order based on the component carrier number and the sub-frame number of multiple downlink signals.

In FIG. 6, sub-frame #0 in the band of component carrier #0 is defined as the first sub-frame at the first turn with a number of “0”. Also, it is assumed that the turn of the sub-frame sequentially increases according to the increase in the sub-frame number within the same component carrier and the order between sub-frames of the component carrier of the next number is arranged again.

That is to say, the bit streams are not arranged in a random order when the initial ACK/NACK signal is generated. Instead, when the initial ACK/NACK signal is generated, ACK/NACK signals of the first sub-frame to fourth sub-frame of the first component carrier are arranged in order, and ACK/NACK signals of the first sub-frame to fourth sub-frame of the second component carrier are then arranged in order.

For example, in the case of a system including two component carriers and two codewords, if two codewords of the first and third sub-frames in the second component carrier band have not been successfully received while the others have been successfully received, a bit stream of (0,0)(1,1)(0,0)(1,1)(1,1)(1,1)(1,1)(1,1) is generated as the first ACK/NACK bit stream.

Of course, the present invention is not limited to the order shown in FIG. 6 and is applicable any order, information of which is shared between a UE and a BS so that a transmitter or BS having received the ACK/NACK feedback can identify the turn of a component carrier, the turn of a sub-frame of the component carrier, and the codeword of the sub-frame, reception of which was success or failure.

According to an embodiment of the present invention, by using joint coding technology combined with PUCCH 2b format and partial bundling and/or partial multiplexing, it is possible to notify multiple ACK/NACK feedbacks through a single uplink carrier in response to multiple downlink carriers or downlink assignments in a TDD LTE-A system including multiple component carriers. Therefore, by encoding, compressing, and transmitting the ACK/NACK information, it is possible to transfer more ACK/NACK information through a single uplink carrier in a resource-effective manner having an excellent protection characteristic.

It should be noted that the present invention is not limited to an embodiment of the present invention in which all elements are incorporated into one element or operated as a single unit in a detailed description thereof. That is, within the range of the object of the present invention, all elements of the present invention may be selectively combined or collectively operated. Further, each of all the elements may be implemented by independent hardware or by a computer program having a program module performing a part of or all the function executable by a part or all of the elements thereof. Codes or code segments of the computer program may be easily conceivable by one skilled in the art. Such a computer program may implement the embodiments of the present invention by being stored in computer readable media and being read and executed by a computer. The storage media of the computer program includes magnetic recoding media, optical recoding media, and carrier wave media.

Further, the term, such as “include”, “comprise”, or “have”, implies, without a particular statement to the contrary, inclusion of a corresponding element and should be interpreted to have a possibility of including another element instead of excluding another element. All terms including technical or scientific terms has, without a different definition, the same meaning as that generally understood by one skilled in the art. Terms generally used, as the terms found in the dictionary, should be interpreted to coincide with the meaning based on the context of related technologies and shall not be interpreted ideally nor excessively formally without a clear definition in the present invention.

Although preferred embodiments of the present invention have been described for illustrative purposes, those skilled in the art will appreciate that various modifications, additions and substitutions are possible, without departing from the scope and spirit of the invention as disclosed in the accompanying claims. Therefore, the embodiments described above should be understood as illustrative not restrictive in all aspects. The present invention is defined only by the scope of the appended claims and must be construed as including the meaning and scope of the claims, and all changes and modifications derived from equivalent concepts of the claims.

What is claimed is:

1. A communication apparatus performing ACK/NACK signal feedback, which transmits an ACK/NACK signal in an uplink in a downlink/uplink asymmetric communication system using at least one component carrier, the communication apparatus comprising:
a reception success-failure determination unit for determining success or failure in receiving a multiple downlink signal through each component carrier;
an ACK/NACK signal generation unit for selectively generating an ACK/NACK signal indicating success or failure in receiving a multiple downlink signal of at least one component carrier according to the number of component carriers; and
a transmission unit for transmitting the ACK/NACK signal through an uplink channel.

2. The communication apparatus of claim 1, wherein the ACK/NACK signal generation unit selectively generates an ACK/NACK signal selectively comprising at least one of an initial ACK/NACK signal, a partially bundled ACK/NACK signal, and a partially multiplexed ACK/NACK signal, based on the number of component carriers.

3. The communication apparatus of claim 2, wherein the ACK/NACK signal generation unit uses one of the initial ACK/NACK signal and the partially bundled ACK/NACK signal when the number of component carriers is two, uses one of the partially bundled ACK/NACK signal and the partially multiplexed ACK/NACK signal when the number of component carriers is three or four, and uses the partially bundled ACK/NACK signal when the number of component carriers is five.

4. The communication apparatus of claim 2, wherein the ACK/NACK signal generation unit comprises:
an initial ACK/NACK signal generation unit for generating the initial ACK/NACK signal;
a partially bundled ACK/NACK signal generation unit for generating a partially bundled ACK/NACK signal;
a partially multiplexed ACK/NACK signal generation unit for generating a partially multiplexed ACK/NACK signal;
an encoder for coding k bits of partially bundled or partially multiplexed data into a predetermined number (N) of bit streams; and
a modulator for modulating N bits of coding data into N bit streams.

5. The communication apparatus of claim 4, wherein the encoder is a Reed-Muller encoder wherein N=20, and the modulator performs QPSK modulation, so as to generate a final ACK/NACK having a maximum of 10 bits (M=10).

6. The communication apparatus of claim 2, wherein the partially bundled ACK/NACK signal generation unit performs a logical AND operation on ACK/NACK bits of all multiple downlink sub-frames with respect to each codeword within each component carrier, thereby generating a partially bundled ACK/NACK signal including bit streams, the number of which is a twice multiple of the total number of component carriers.

7. The communication apparatus of claim 2, wherein the partially multiplexed ACK/NACK signal generation unit performs a logical AND operation on ACK/NACK bits of all codewords with respect to each multiple downlink sub-frame within each component carrier, thereby generating a partially multiplexed ACK/NACK signal including bit streams, the number of which is equal to the number of multiple downlink sub-frames in each component carrier.

8. The communication apparatus of claim 1, wherein, in the ACK/NACK signal generated by the ACK/NACK signal generation unit, bit streams of the ACK/NACK signal are arranged in a predetermined order based on the numbers of the sub-frames and the component carriers.

9. An ACK/NACK signal feedback method by a communication apparatus, which transmits an ACK/NACK signal in an uplink in a downlink/uplink asymmetric communication system using at least one component carrier, the ACK/NACK signal feedback method comprising:
determining success or failure in receiving a multiple downlink signal through each component carrier;
selectively generating an ACK/NACK signal indicating success or failure in receiving a multiple downlink signal of at least one component carrier according to the number of component carriers; and
transmitting the ACK/NACK signal through an uplink channel,
wherein the ACK/NACK signal selectively comprises at least one of an initial ACK/NACK signal, a partially bundled ACK/NACK signal, and a partially multiplexed ACK/NACK signal, based on the number of component carriers.

10. The ACK/NACK signal feedback method of claim 9, wherein the ACK/NACK signal is a bitstream signal of 10 bits (M=10) and is transmitted through PUCCH format 2b.

11. An ACK/NACK signal transmission method, in which a communication apparatus transmits a multi-ACK/NACK signal, which is a signal reporting success/failure in receiving multiple downlink component carriers, in an uplink in a downlink/uplink asymmetric communication system using multiple component carriers,
wherein the communication apparatus transmits the multi-ACK/NACK signal for the multiple downlink component carriers through a single uplink component carrier.

12. A communication apparatus for generating a multi-ACK/NACK signal, which is a signal reporting success/failure in receiving multiple downlink component carriers, in an uplink in a downlink/uplink asymmetric communication system using multiple component carriers,
wherein the communication apparatus generates the multi-ACK/NACK signal by using partial multiplexing or partial bundling of ACK/NACK data for each downlink component carrier and PUCCH 2b format, and transmits the generated multi-ACK/NACK signal through a single uplink component carrier.
